(19) United States
(12) Patent Application Publication
(10) Pub. No.: US 2021/0292012 A1
(43) Pub. Date: Sep. 23, 2021

(54) SYSTEMS AND METHODS OF GALACTIC TRANSPORTATION

(71) Applicant: Sandeep Kumar Chintala, London (GB)

(72) Inventors: Sandeep Kumar Chintala, London (GB); Rasakatla Sriranjan, Hyderabad (IN)

(21) Appl. No.: 16/493,575

(22) PCT Filed: Mar. 13, 2018
(86) PCT No.: PCT/GB2018/050631

§ 371 Date: Sep. 12, 2019

(30) Foreign Application Priority Data
Mar. 13, 2017 (IN) 201741008604

(51) Int. Cl. B64G 1/40; B64G 1/00; B64G 5/00; B64G 1/62

(52) U.S. Cl. CPC B64G 1/409; B64G 1/62; B64G 5/00; B64G 1/002

(57) ABSTRACT

The present subject matter relates to a system and a method for galactic transportation (100). The galactic transportation system (100) may comprise multiple rails (102) arranged in a first direction (103), a platform (108) for supporting a transporter (202), and a control unit (106). Further, the multiple propulsion coils (104) may be arranged in the first direction (103) on one or more of the rails (102). The transporter (202) may further comprise multiple propulsion modules (206). The propulsion coils (104) on the rails (102) may be activated to exert an electromagnetic repulsive force on the propulsion modules (206) of the transporter (202) for propulsion of the transporter (202).

### TECHNICAL FIELD

The present subject matter relates, in general, to launch techniques and, in particular, to galactic transportation techniques.

### BACKGROUND

Space launch systems are used to carry a payload from the Earth's surface to either an orbit around the Earth or to some other destination into an outer space. A space launch system generally comprises a space launch vehicle, a launch pad, and other supporting infrastructure. Generally, the space launch vehicle is vertically launched from the launch pad along with the payload that may include different units, such as a satellite and protective covering of the satellite. The space launch vehicle generates thrust, and thus, acceleration to the payload due to which it overcomes the Earth's gravitational pull and provides necessary escape velocity to the payload to enter into the outer space.

### BRIEF DESCRIPTION OF THE DRAWINGS

The detailed description is described with reference to the accompanying figures. In the figures, the left-most digit of a reference number identifies the figure in which the reference number first appears. The same numbers are used throughout the figures to reference the same elements.

FIG. 1 illustrates a perspective view of the galactic transportation system, in accordance with an example implementation of the present subject matter.

FIG. 2 illustrates a perspective view of the galactic transportation system with a transporter, in accordance with an example implementation of the present subject matter.

FIG. 3 illustrates a transporter along with an infrared emitter and infrared receiver for detecting movement of the transporter, in accordance with an example implementation of the present subject matter.

FIG. 4 illustrates a cross-sectional view of the transporter, in accordance with an example implementation of the present subject matter.

FIGS. 5(a) and 5(b) illustrates outer structure of the transporter, in accordance with an example implementation of the present subject matter.

FIGS. 6(a) and 6(b) illustrate a front view and a side view, respectively, of a docking station for docking the transporter, in accordance with an example implementation of the present subject matter.

FIG. 7 illustrates a method of operation of the transporter, in accordance with an example implementation of the present subject matter.

FIG. 8 illustrates a method of launching the transporter, in accordance with an example implementation of the present subject matter.

### DETAILED DESCRIPTION

Generally, a space launch vehicle is powered by propellants to accelerate the payload and attain an escape velocity to overcome Earth's gravitational pull. As a result, the space launch vehicle along with the payload is subjected to very high acceleration, and therefore, the space launch vehicle as well as the payload experiences very high g-forces during their upward journey. Moreover, the acceleration experienced by the space launch vehicle along with the payload during a launch operation is also uncontrolled.

However, electronic components such as the inertial navigation system, telemetry link for diagnostic flight data, and wireless camera link, used in the payload can generally sustain a maximum g-force of about 2000 g. Due to the uncontrolled acceleration produced during launch, it is difficult to regulate the acceleration experienced by the payload. As a result, the electronic components housed in the payload may fail during launch. Building superior quality components that can withstand extreme conditions is both, time consuming and cost intensive.

The present subject matter describes techniques for galactic transportation. In an example implementation, a galactic transportation system is described for a transporter, such as a space launch vehicle. In the example implementation, the galactic transportation system provides controlled acceleration to the transporter by accelerating the transporter in a controlled manner. In an example, the galactic transportation system may include multiple rails that may be arranged in a first direction to guide the transporter. The galactic transportation system may further include multiple propulsion coils arranged in the first direction on one or more rails of the multiple rails.

While launching the transporter, the multiple propulsion coils may be successively activated in the first direction to generate an electromagnetic field and, thus an electromagnetic repulsive force is exerted on the transporter. As the multiple propulsion coils are successively activated, the electromagnetic repulsive force exerted on the transporter is in a controlled, or step by step manner. This results in a step by step acceleration of the transporter. Therefore, since the transporter is accelerated in a step by step by manner, the acceleration provided to the transporter is controlled, thereby preventing damage to the electronic components of the payload, e.g., a satellite, during launching. The use of multiple propulsion coils and successive activation of the propulsion coils may allow usage of regular electronic components in the transporter, which may provide for reduced cost of manufacturing space launch vehicles. Further, the use of regular electronic components may also reduce production time of the components, which may allow faster manufacturing of the transporter.

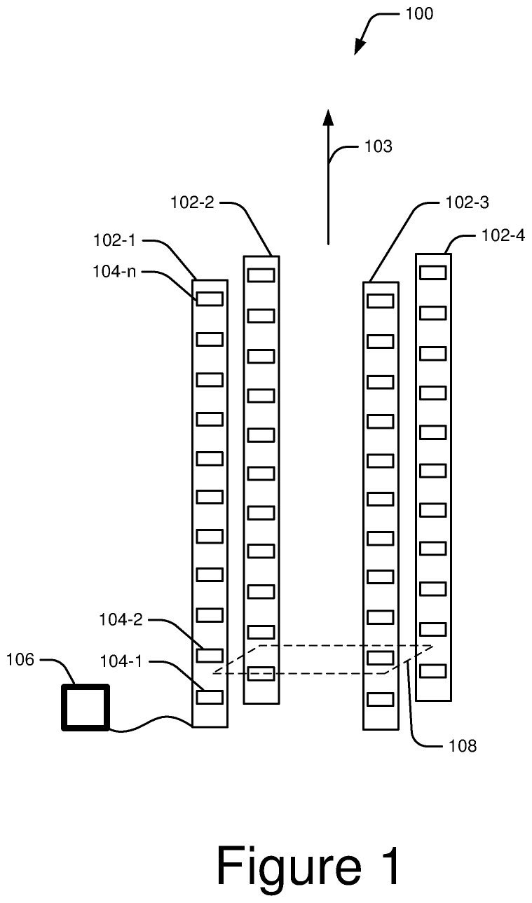

The galactic transportation system is further described with reference to FIG. 1 to FIG. 8. It should be noted that the description and the figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates a perspective view of the galactic transportation system 100, in accordance with an example implementation of the present subject matter. The galactic transportation system 100 may include multiple rails 102-1, 102-2, 102-3, and 102-4 arranged in a first direction 103. For the ease of explanation, the multiple rails have been commonly referred to as rails 102, hereinafter. In an example implementation, the first direction 103 may be a vertical direction. In another example implementation, the first direction 103 may be at a predefined angle with respect to the vertical direction. In an example implementation, one or more rail from amongst the multiple rails 102 may have a length of about 3000 m.

The galactic transportation system 100 further includes multiple propulsion coils 104-1, 104-2, . . . , 104-n, which are arranged on one or more of the multiple propulsion coils 104-1, 104-2, . . . , 104-n. For the ease of explanation, the multiple propulsion coils have been commonly referred to as propulsion coils 104, hereinafter. In an example implementation, the propulsion coils 104 may be arranged in the first direction 103. In an example implementation, one or more of the propulsion coil 104 may be a magnetic coil.

In the example, one or more of the propulsion coils 104 may include at least one energy storage unit to generate current. The energy storage units flush out current, for example, of more than 500 Ampere (A) in a short discharge time. Further, inverters may also be utilized to generate high current and then storing it in capacitive storage units through a charging circuit. In an example implementation, discharge from the energy storage units is controlled to provide a controlled current to the propulsion coils 104. In another example implementation, one or more propulsion coils 104 may be powered by a perpetual energy source.

The galactic transportation system 100 may further include a control unit 106, and a platform 108 over which a transporter may be placed before a launch operation. The control unit 106 controls and powers the propulsion coils 104 arranged on one or more of the rails 102. In an example, the control unit 106 may include a power source which may include solar panels, hydrogen cells, portable nuclear power systems, and the like. In an example implementation, the power source may include a perpetual energy source.

During a launch operation, while launching a transporter into outer space using the galactic transportation system 100, the propulsion coils 104 along the one or more of the rails 102 are successively activated in the first direction 103. This successive activation of the propulsion coils 104 generates an electromagnetic filed. In an example implementation, the transporter 202 may include propulsion modules to generate an electromagnetic field. In the example implementation, the electromagnetic field generated by the propulsion coils may interact with the electromagnetic field of the transporter 202 to exert electromagnetic repulsive force on the transporter. Since the propulsion coils 104 are successively activated, the electromagnetic repulsive force exerted on the transporter 202 is in controlled. Therefore, the transporter 202 is subjected to a controlled force and, thus the acceleration of the transporter 202 is also controlled. In an example, the electromagnetic repulsive force exerted on the transporter 202 is to provide escape velocity to the transporter 202 to launch it onto the outer space. A detailed implementation of the galactic transportation system 100 for launching a space launch vehicle, such as the transporter 202, has been explained with reference to the details in the forthcoming figure explanations.

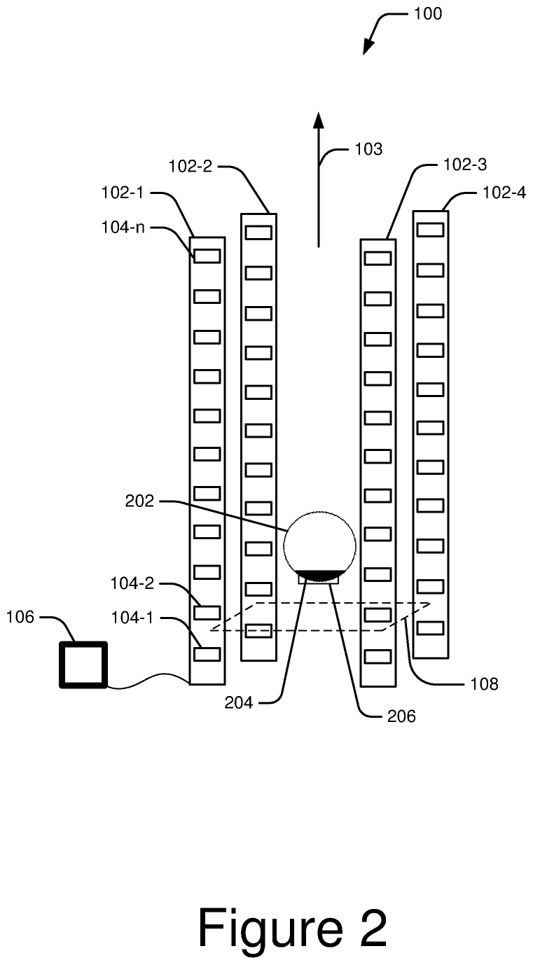

FIG. 2 illustrates a perspective view of the galactic transportation system 100 with a transporter 202 during a launch operation, in accordance with an example implementation of the present subject matter. As explained earlier, the galactic transportation system 100 may include the rails 102 arranged in the first direction 103, and the propulsion coils 104 arranged in the first direction 103 on one or more of the rails 102. Further, the galactic transportation system 100 may further include a control unit 106 and a platform 108. Furthermore, the transporter 202 may include a launch contact area 204, where multiple propulsion modules 206 may be coupled to the launch contact area 204. In an example, the propulsion modules 206 may be electromagnetic modules. The transporter 202 may be used for carrying a payload, such as a satellite, from a launch location to a destination location. Further, the propulsion coils 104 and the propulsion modules 206 may include energy storage units to provide a high current to generate an electromagnetic filed and exert an electromagnetic repulsive on the transporter 202. In an example implementation, the propulsion coils 104 and the propulsion modules 206 may be powered by a perpetual energy source.

During a launch operation, the transporter 202 may be docked on the platform 108 such that the launch contact area 204 abuts the platform 108 from above. After this, one or more of the propulsion modules 206 on the transporter 202 may be activated to generate an electromagnetic filed. Thereafter, the one or more propulsion coils 104 on at one or more of the rails 102 is successively activated to generate an electromagnetic field and thus exerts an electromagnetic repulsive force on the propulsion modules. In an example implementation, the propulsion modules 206 and the propulsion coils 104 may be activated to be configured as one of magnetic north pole and magnetic south pole at a predefined strength, such that the propulsion coils 104 exerts the electromagnetic repulsive force on the propulsion modules 206 of the transporter 202.

In an example implementation, the propulsion coils 104 and the propulsion modules 206 are supplied with a high current from their respective energy storage units to generate the electromagnetic field. In an example, the energy storage units may be one of capacitive storage units and batteries. During the launch operation, discharge from energy storage units of the propulsion modules 206 is synchronized with the discharge from the energy storage units of the propulsion coils 104 arranged on the one or more of rails 102.

Further, in an example implementation, the successive activation of the propulsion coils 104 may be followed until the transporter 202 achieves a predefined escape velocity to launch the transporter 202 into the outer space. In another example implementation, as the transporter 202 moves in the first direction 103, the propulsion coils 104 on the rails 102 may be successively deactivated. Thereby, saving energy being supplied to the propulsion coils 104.

As the electromagnetic repulsive force is exerted on the transporter 202 due to successive activation of the propulsion coils 104, the transporter is accelerated in a step by step manner. In an example, the acceleration experienced by the payload is not allowed to increase beyond a threshold limit to avoid damage to the electronic components of the satellite, where the threshold limit vary depending upon different conditions, such as payload type, weight of the payload, and the like. In an example implementation, the threshold limit may be 2000 g. Thus, the electronic components of the payload housed inside the transporter 202 are protected against the damage that may be caused due to fluctuating g-forces. In an example, current supplied to the propulsion coils on the rails 102 may be regulated to vary the electromagnetic field generated, thereby providing controlled acceleration to the transporter 202.

In another example implementation, a docking pad (not shown in FIG. 2) may be provided at a destination location, where the docking pad may also be installed with multiple propulsion modules. The docking pad may be utilized to safely land the transporter 202 at the destination location, once the transporter 202 has been launched from a launch location. The propulsion modules at the docking pad are magnetically coupled with the propulsion modules of the transporter 202. While landing the transporter 202 at the destination location, the propulsion modules at the docking pad may first be set to magnetic poles opposite to that of the magnetic poles set on the propulsion modules of the transporter 202. As a result, the transporter 202 may first be pulled towards the docking pad. In an example, strength of the magnetic poles set on the propulsion modules of the docking pad may be relatively lower than that of the magnetic poles set on propulsion modules of the transporter 202.

Thereafter, the propulsion modules on the docking pad may be switched to magnetic poles similar to that of the magnetic poles set on the propulsion modules of the transporter 202. As a result, impact of the transporter 202 at the docking pad during a landing operation is minimized and, further, the transporter is facilitated to get closer to the landing pad and, thereby enabling the transporter 202 to just hover over the docking pad and land safely.

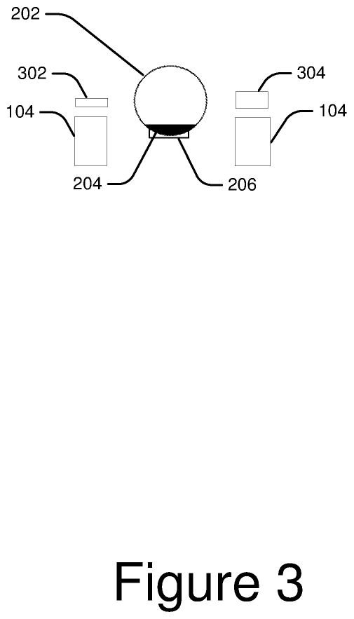

FIG. 3 illustrates a transporter 202 along with an infrared emitter 302 and infrared receiver 304 for detecting movement of the transporter 202, in accordance with an example implementation of the present subject matter. FIG. 3 describes a front view of the galactic transportation system 100, where two propulsion coils from amongst the propulsions coils 104 on two of the rails 102 (not shown in FIG. 3), are shown. As per FIG. 3, one propulsion coil includes an infrared emitter 302 and the other propulsion coil includes an infrared receiver 304. Though FIG. 3 describes two propulsion coils along with one infrared emitter and one infrared receiver, it should be noted that one or more propulsion coil may include an infrared emitter 302 and an infrared receiver 304 to detect movement of the transporter 202 as the transporter 202 is propelled. Further, in an example implementation, alternate propulsion coils from amongst the propulsion coils 104 may include at least one of an infrared emitter 302 and an infrared receiver to detect movement of the transporter 202.

During a launch operation, when the transporter 202 is propelled in the first direction 103, an infrared signal emitted by the infrared emitter 302 gets disconnected from the infrared receiver 304, thereby detecting the movement of transporter 202. Accordingly, as the transporter 202 is propelled in the first direction 103, one or more propulsion coils along the rails 102 in the first direction 103 may be further activated. Now, as the transporter 202 moves further in the first direction 103, the propulsion coils 104 is successively deactivated. Thus, the activation and deactivation of the propulsion coils 104 are synchronized with the movement of transporter 202 in the first direction 103. This simultaneous activation and deactivation of the propulsion coils 104 may be followed until the transporter 202 achieves an escape velocity.

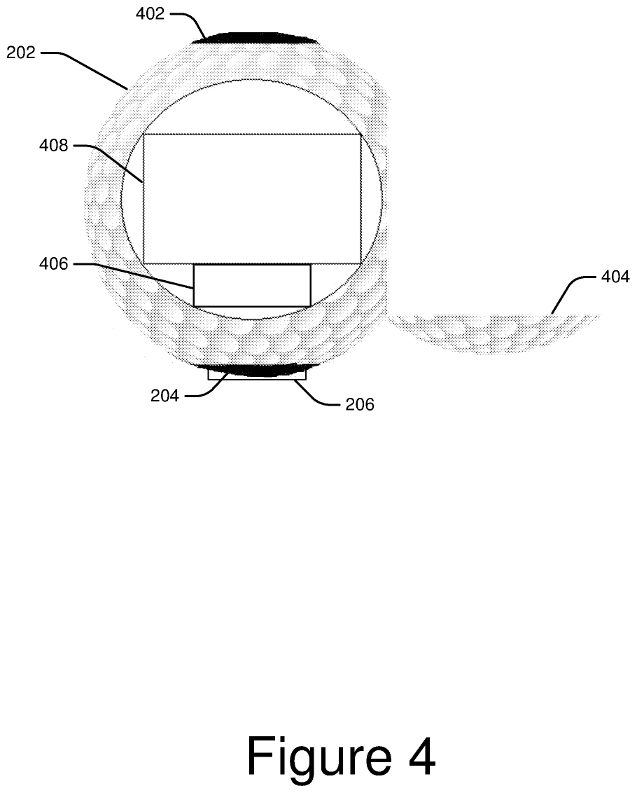

FIG. 4 shows a cross-sectional view of the transporter 202, in accordance with an example implementation of the present subject matter. The transporter 202 may comprise a launch contact area 204, multiple propulsion modules 206, a safety module 402, an in-flight obstacle avoidance module (not shown in FIG. 4), a transporter control module, a hatch opening system 404, a motion control module 406, and a cabin module 408. In an example, the propulsion modules 206 may be coupled to the launch contact area 204 for propelling the transporter 202. In an example implementation, the propulsion modules 206 may include energy storage units to provide a high current to generate an electromagnetic filed and exert an electromagnetic repulsive on the transporter 202. In an example, the energy storage units may be one of capacitive storage units and batteries. In another example implementation, one or more of the propulsion modules 206 may be powered by a perpetual energy source.

Further, the safety module 404 may include different components, such as parachutes, anti-collision units, and the like, to enable the transporter 202 to land safely at a destination location. The hatch opening module 404 allows ingress and egress of a payload into the transporter 202. The motion control module 406 helps to maintain the cabin module 408 in a steady state. In addition, the motion control module 406 prevents the cabin module 408 from spinning while in flight. Further, the motion control module may control the activation of the propulsion modules for propulsion of the transporter 202.

In an example implementation, the cabin module 408 may be completely detachable from the transporter 202 and may transform into a mobility vehicle that can maneuver on its own. The transporter control module may be remotely controlled by a portable electronic device or directly from inside the cabin module 408 and may enable a user to select required destination locations on planetary bodies, such as the Earth, Moon, Mars, and the like. The transporter control module may model various trajectory paths to the destination location and determine the most suitable trajectory path depending on the time of launch, the power availability from the transporter 202 in combination with the power availability at the launch pad at a launching time and other impacting factors, such as total weight of the transporter 202, atmospheric conditions, distance between launch position and destination, and the like.

Further, the transporter launch control module also avoids the possibility of any collision with other flying objects, geo-stationary satellites, and any other planetary objects. The in-flight obstacle avoidance module helps in navigating the transporter 202 after the launch and, further, helps in avoiding obstacles that may come in the set trajectory of the transporter 202.

In operation, for launching the transporter 202 into outer space, the motion control module 406 may activate the propulsion modules 206 to configure one or more of the propulsion modules 206 as one of magnetic north pole and magnetic south pole to generate an electromagnetic field. The electromagnetic field generated by the propulsion modules exerts electromagnetic force on the transporter 202 for propulsion of the transporter 202. In an example implementation, the transporter 202 may be launched by the galactic transportation system 100. As explained earlier, the propulsion coils 104 on one or more of the rails 102 may be successively activated to exert an electromagnetic repulsion force on the transporter 202. Thus, the transporter 202 is accelerated to achieve an escape velocity.

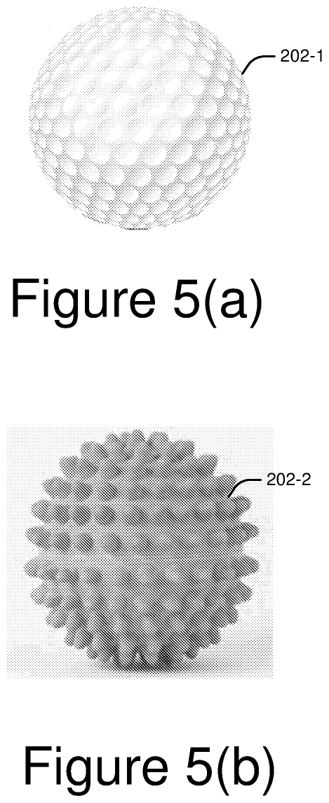

FIGS. 5(a) and 5(b) illustrate an outer structure of the transporter 202, in accordance with an example implementation of the present subject matter. The outer structure of the transporter 202 is provided with thermal protection shield to protect the transporter 202 from extreme heat of the atmosphere during exit and re-entry of the transporter 202 on Earth, as well as from the varying high and low temperatures of the outer space and other planetary bodies. Although the transporter 202 has been depicted to be spherical in shape, it would be appreciated that the transporter 202 may be of any other shape as well, such as oval.

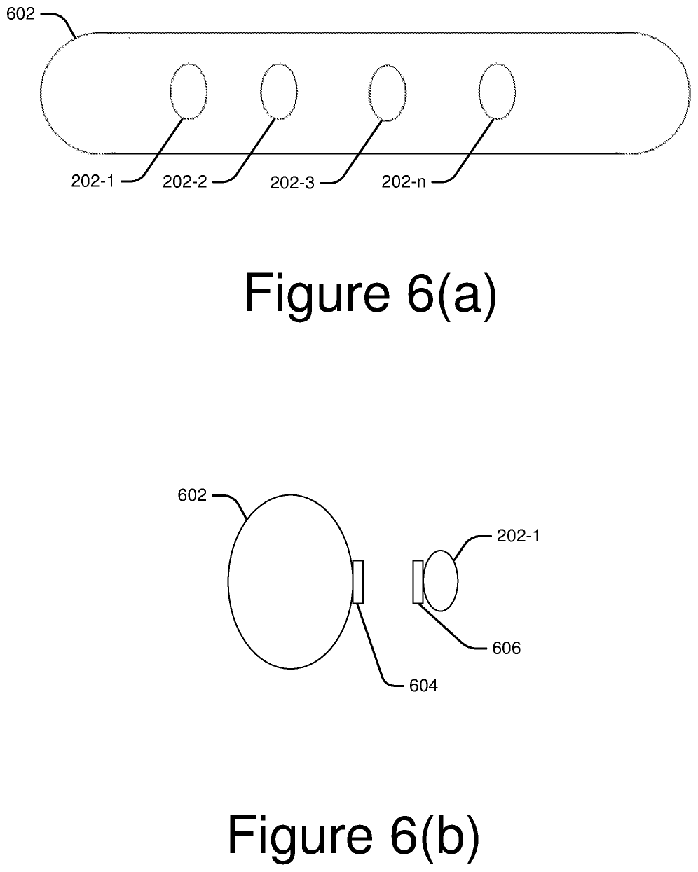

FIGS. 6(a) and 6(b) depict docking of the transporter 202 at a docking station 602, in accordance with an example implementation of the present subject matter. In the example implementation, the transporter 202 may dock to the docking station 602, such as a spaceship. In an example, the docking station 602 may be located in the outer space. FIG. 6(a) shows a front view of multiple transporters 202-1, 202-2, 202-3, . . . , 202-n docked at the docking station 602. Further, FIG. 6(b) shows a side view of the docking station 602 with the multiple transporters 202-1, 202-2, 202-3, . . . , 202-n undocked from the docking station 602.

In an example, the propulsion modules 606 may be installed at a docking side on the docking station 602. The propulsion modules 606 allow the transporters 202-1, 202-2, 202-3, . . . , 202-n to dock at the docking station 602 and undock from the docking station 602. In operation, the propulsion modules 606 of the docking station 602 are supplied with an electric current to configure them as magnetic poles, such as magnetic north pole and magnetic south pole.

For a docking operation at the docking station 602, the transporters 202-1, 202-2, 202-3, . . . , 202-n are oriented such that the propulsion modules on the transporters 202-1, 202-2, 202-3, . . . , 202-n and the docking station 602 are positioned opposite to each other.

Thereafter, the electromagnetic modules on the of transporters 202-1, 202-2, 202-3, . . . , 202-n and the docking station 602 may be actuated such that the propulsion modules on the docking station and the transporter are set to opposite magnetic poles. That is, the propulsion modules at the docking station 602 may be set to magnetic south poles and the propulsion modules at the transporter 202-1, 202-2, 202-3, . . . , 202-n may be set to magnetic north poles, or vice versa. As a result, the transporters 202-1, 202-2, 202-3, . . . , 202-n experience electromagnetic attractive forces and are thus attracted towards the docking station 602, thereby docking the transporters 202-1, 202-2, 202-3, . . . , 202-n at the docking station 602.

Similarly, for an undocking operation, the propulsion modules at the docking station 602 and the transporters 202-1, 202-2, 202-3, . . . , 202-n are activated to like-like magnetic poles, i.e., either magnetic south poles or magnetic north poles. As a result, electromagnetic repulsion forces are generated between the transporters 202-1, 202-2, 202-3, . . . , 202-n and the docking station 602, and thereby, the transporters 202-1, 202-2, 202-3, . . . , 202-n are undocked from the docking station 602.

In the example implementation, the transporters 202-1, 202-2, 202-3, . . . , 202-n may include radio frequency (RF) beacons. In an example, the RF beacons may utilize radio waves for identification of the location of a propulsion module 604 on the docking station 602. In the example, the RF beacons may measure altitude data and position data of the transporters 202-1, 202-2, 202-3, . . . , 202-n with respect to the docking station 602. Further, in the example, relative orientation of each transporter 202-1, 202-2, 202-3, . . . , 202-n and the docking station 602 may be measured using an inertial measurement sensor installed on the transporters 202-1, 202-2, 202-3, . . . , 202-n, in combination with the altitude and position data obtained using the RF beacons. The data obtained from the RF beacons and the inertial measurement sensor is utilized to accurately position the transporters 202-1, 202-2, 202-3, . . . , 202-n with respect to the docking station 602 and to safely dock the transporters 202-1, 202-2, 202-3, . . . , 202-n at the docking station 602.

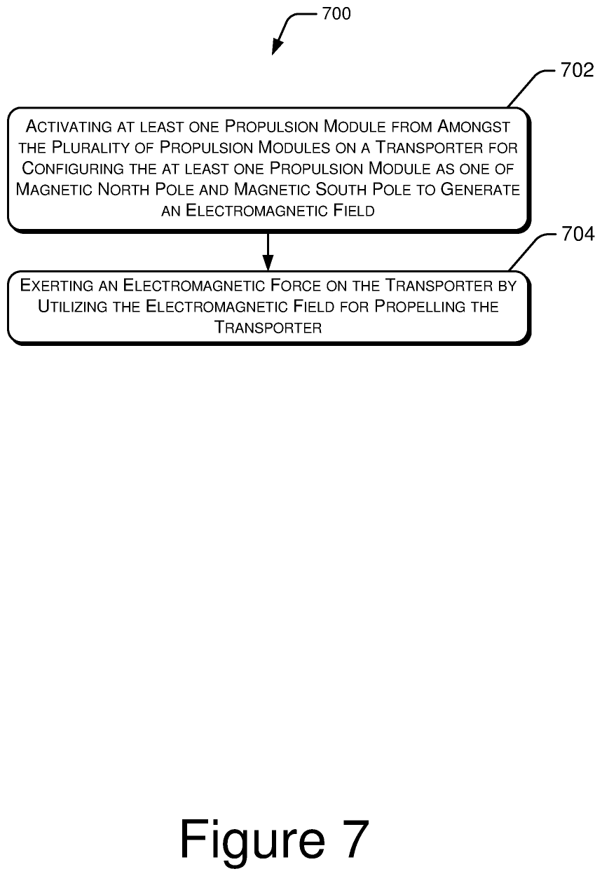

FIG. 7 describes a method 700 of operation of the transporter 202, in accordance with an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing system(s), through any suitable hardware, non-transitory machine-readable instructions, or combination thereof.

At block 702, one or more propulsion module from amongst the propulsion modules 206 on the transporter 202 may be activated for configuring the one or more propulsion module as one of magnetic north pole and magnetic south pole to generate an electromagnetic field.

Further, at block 704, an electromagnetic force is exerted on the transporter 202 due to the electromagnetic field for propulsion of the transporter 202. In an example implementation, the propulsion modules 206 of the transporter 202 may interact with the propulsion coils 104 of the rails 102 of the galactic transportation system 100 to exert the electromagnetic force on the transporter 202 for propulsion. In an example implementation, the propulsion modules 206 on the transporter 202 may be electromagnetic modules.

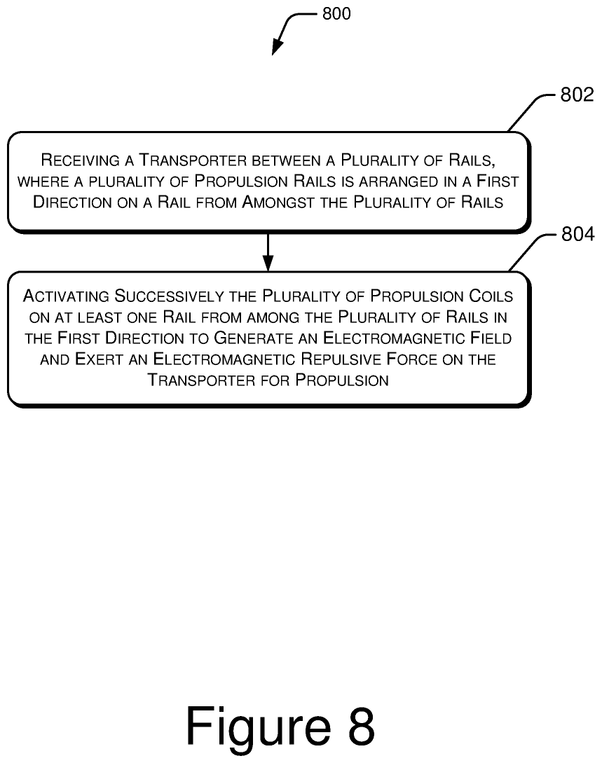

FIG. 8 describes a method 800 of launching the transporter 202 using the galactic transportation system 100, in accordance with an example implementation of the present subject matter. The order in which the method 800 is described is not intended to be construed as a limitation, and any number of the described method blocks may be combined in any order to implement the method 800, or an alternative method. Furthermore, the method 800 may be implemented by processor(s) or computing system(s), through any suitable hardware, non-transitory machine-readable instructions, or combination thereof.

At block 802, the transporter may be received between the rails 102 of the galactic transportation system 100. As explained earlier, multiple propulsion coils 104 may be arranged in a first direction 103 on one or more of the propulsion rails 102. In an example implementation, the transporter 202 may be docked on a platform 108 provided between the rails 102.

At block 804, the propulsion coils 104 on the rails 102 may be successively activated in the first direction 103 to generate an electromagnetic field and thereby exert an electromagnetic repulsive force in the first direction 103 on the transporter 202 for propulsion of the transporter 202.

In an example implementation, one or more of the propulsion coils 104 may be configured as one of magnetic north pole and magnetic south pole to exert the electromagnetic repulsive force on the transporter 202 for propelling the transporter 202 in the first direction 103. As the transporter 202 is propelled in the first direction 103 by the successive activation of the propulsion coils 104, the transporter 202 is accelerated. In an example, the acceleration provided to the transporter 202 may be controlled by varying the current supplied to the propulsion coils 104.

Thus, the transporter 202 is accelerated in a step by step manner and the acceleration provided to the transporter 202 is controlled within a predefined threshold limit. Therefore, as the transporter 202 is accelerated in a controlled manner, the electronic components of the payload carried by the transporter 202 are not subjected to high g-forces. Thus, the electronic components of the payload such as a satellite are saved from failure. Thus, the galactic transportation system 100 provides an effective way of launching a payload.

In an example implementation, the method 800 may further include detecting movement of the transporter 202 as the transporter 202 is propelled in the first direction. In the example implementation, the movement of the transporter 202 is detected by utilizing an infrared emitter 302 and an infrared detector 304. In operation, when the transporter 202 is propelled in the first direction 103, the signal emitted by the infrared emitter 302 may get cut from the infrared receiver 304. Thereby, detecting the movement of the transporter 202.

In another example implementation, the method 800 may further include successively deactivating the propulsion coils 104 on one or more of the rails 102, based on the detection of the movement of the transporter 202, as the transporter is propelled in the first direction 103.

Although implementations of the galactic transportation system as per the present subject matter have been described in a language specific to structural features and/or applications, it is to be understood that the present subject matter is not limited to the specific features or applications described. Rather, the specific features and applications are disclosed as exemplary implementations.

I/We claim:

1. A galactic transportation system (100) comprising:
a plurality of rails (102) arranged in a first direction (103) to guide a transporter (202); and
a plurality of propulsion coils (104) arranged in the first direction (103) on at least one rail from among the plurality of rails (102), wherein the plurality of propulsion coils (104) is successively activated to generate an electromagnetic field and exert an electromagnetic repulsive force on the transporter (202) for propulsion.

2. The galactic transportation system (100) as claimed in claim 1, wherein at least one propulsion coil from amongst the plurality of propulsion coils (104) is a magnetic coil.

3. The galactic transportation system (100) as claimed in claim 2, wherein at least one propulsion coil from amongst the plurality of propulsion coils (104) is configured as one of magnetic north pole and magnetic south pole to exert the electromagnetic repulsive force on the transporter (202).

4. The galactic transportation system as claimed in claim 3, wherein the first direction (103) is at a predefined angle with respect to a vertical direction.

5. The galactic transportation system (100) as claimed in claim 1, wherein the plurality of propulsion coils (104) is simultaneously activated in the first direction (103).

6. The galactic transportation system (100) as claimed in claim 1, wherein the plurality of propulsion coils (104) is further successively deactivated in the first direction (103) as the transporter (202) is propelled in the first direction (103).

7. The galactic transportation system (100) as claimed in claim 1, wherein a propulsion coil from amongst the plurality of propulsion coils (104) comprises a capacitive storage unit, and wherein the capacitive storage unit provides a current of more than 500 Ampere (A) to the propulsion coil.

8. The galactic transportation system (100) as claimed in claim 1, wherein at least one propulsion coil from amongst the plurality of propulsion coils (104) is powered by a perpetual energy source.

9. The galactic transportation system (100) as claimed in claim 1, wherein at least one propulsion coil from amongst the plurality of propulsion coils (104) comprises an infrared emitter (302) and an infrared receiver (304) to detect movement of the transporter (202).

10. The galactic transportation system (100) as claimed in claim 1, comprises a platform (108) located between the plurality of rails (102) to dock the transporter (202).

11. A transporter (202) for galactic transportation, the transporter (202) comprising:
a plurality of propulsion modules (206) to generate an electromagnetic field; and
a motion control module (406) to control a plurality of propulsion coils (104), wherein the motion control module (406) activates the plurality of propulsion modules (206) to configure at least one propulsion module from amongst the plurality of propulsion modules (206) as one of magnetic north pole and magnetic south pole to generate the electromagnetic field for propulsion of the transporter (202).

12. The transporter (202) as claimed in claim 11, wherein the electromagnetic field generated by the motion control module (406) exerts electromagnetic force on the transporter (202) for propulsion.

13. The transporter (202) as claimed in claim 11, wherein the plurality of propulsion modules (206) is coupled to a launch contact area (204) of the transporter (202).

14. The transporter (202) as claimed in claim 11, wherein the at least one propulsion module from amongst the plurality of propulsion modules (206) comprises a capacitive storage unit, and wherein the capacitive storage unit provides a current of more than 500 Ampere (A) to the at least one propulsion module.

15. The transporter (202) as claimed in claim 1, wherein at least one propulsion module from amongst the plurality of propulsion modules (206) is powered by a perpetual energy source.

16. The transporter (202) as claimed in claim 11, wherein the transporter (202) comprises:
a cabin module (408) to receive a payload; and
a hatch opening module (404) coupled to the cabin module (408) to allow ingress and egress of the payload from the transporter (202).

17. The transporter (202) as claimed in claim 15, wherein the transporter (202) comprises a safety module (402) including at least one of parachutes and anti-collision units to land the transporter (202) at a destination location.

18. A method of launching a transporter (202) comprising:
receiving a transporter (202) between a plurality of rails (102), wherein a plurality of propulsion coils (104) is arranged in a first direction (103) on a rail from amongst the plurality of rails (102); and
activating successively the plurality of propulsion coils (104) on at least one rail from among the plurality of rails (102) in the first direction (103) to generate an electromagnetic field and exert an electromagnetic repulsive force on the transporter (202) for propulsion.

19. The method as claimed in claim 18, wherein the transporter (202) is docked on a platform (108) located between the plurality of rails (102) during a launch operation.

20. The method as claimed in claim 18, the method comprising configuring a propulsion coil from amongst the plurality of propulsion coils (104) as one of magnetic north pole and magnetic south pole to exert the electromagnetic repulsive force on the transporter (202).

21. The method as claimed in claim 18, wherein the method comprises detecting movement of the transporter (202) as the transporter (202) is propelled in the first direction (103) by utilizing an infrared emitter (302) and an infrared receiver (304) coupled to at least one propulsion coil from amongst the plurality of propulsion coils (104).

22. The method as claimed in claim 20, wherein the method further comprises successively deactivating the plurality of propulsion coils (104) on at least one rail from amongst the plurality of rails (102), based on the detected movement of the transporter (202), as the transporter (202) is propelled in the first direction (103).

23. The method as claimed in claim 22, wherein the plurality of propulsion coils (104) is successively deactivated in the first direction (103).

24. A method comprising:
activating at least one propulsion module from amongst a plurality of propulsion modules (206) on a transporter (202) for configuring the at least one propulsion module as one of magnetic north pole and magnetic south pole to generate an electromagnetic field; and
exerting an electromagnetic force on the transporter (202) by utilizing the electromagnetic field for propulsion of the transporter (202).

25. The method as claimed in claim 24, wherein the at least one propulsion module from amongst the plurality of propulsion modules (206) is an electromagnetic module.
